(19) United States
(12) Patent Application Publication
(10) Pub. No.: US 2004/0116109 A1
(43) Pub. Date: Jun. 17, 2004

(54) Automatic wireless device configuration

(76) Inventors: Benjamin K. Gibbs, Colorado Spings, CO (US); Marc Meylemans, San Diego, CA (US); Vijay Sarad, Granada Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/321,023

(22) Filed: Dec. 16, 2002

(51) Int. Cl. H04M 3/00

(52) U.S. Cl. 455/419; 455/418

(57) ABSTRACT

A method that enables a wireless mobile communications device and its computing host to be automatically configured for operation based on measurements made through the wireless device by installation software.

Wireless carriers are faced with creating more efficient distribution channels, increasing customer satisfaction, while at the same time increasing margin and profitability. The cost and effort of provisioning handsets and activating users may be reduced using over-the-air service provisioning (OTASP) mechanisms. To transmit Over-the-Air (OTA) configurations to systems, an application first establishes a network connection with a server. Then, authorized users of services may send OTA configuration messages to certain enabled phones via an application interface. Parameters may be specified by the originating application in order to have the configuration message composed and transmitted to the recipient's phone by the service provider.

Carriers also have the need to periodically update parameters stored in the handsets of their user community. The capability to update parameters over-the-air may reduce the cost of having handsets brought into service centers for reprogramming. Therefore, the need exists for a comprehensive and extensible system for over-the-air handset provisioning and parameter administration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a network communication system in which the present invention may be practiced; and

FIG. 2 is a diagram that illustrates a method that may be used to configure and specify parameters to a wireless device communicating in the network of FIG. 1.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the present invention may be used in a variety of applications. Although the present invention is not limited in this respect, the circuits disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

In general, embodiments using the claimed subject matter may provide a benefit to wireless communication devices, and in particular, may be incorporated in communication networks. Note that the embodiments may be integrated into radio systems or hand-held portable devices. Thus, laptop computers, cellular radiotelephone communication systems, two-way radio communication systems, one-way pagers, two-way pagers, personal communication systems (PCS), personal digital assistants (PDA's), cameras and other products are intended to be included within the scope of the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

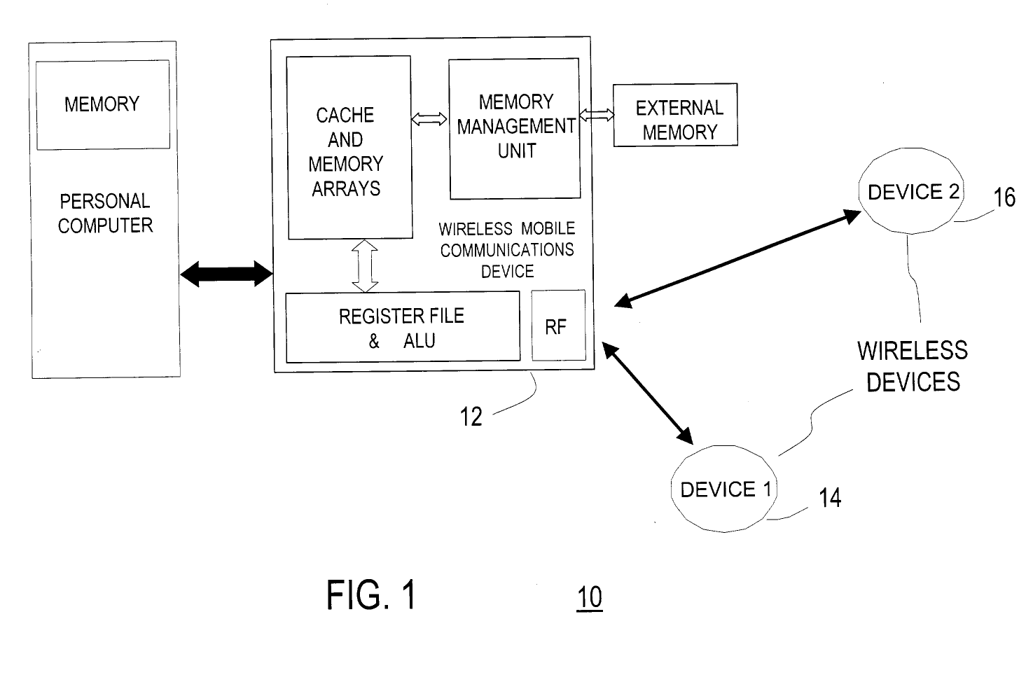

FIG. 1 is a network communication system 10 in which the present invention may be practiced. Accordingly, a mobile wireless mobile communications device 12 may be in communication with other electronic devices 14 and 16. One of electronic devices 14 and 16 may be a base station. Wireless communications device 12 may have internal and external physical memory to store configuration data and an Arithmetic Logic Unit (ALU) to compute data according to various processes and algorithms. The operating system running on the core processor of communications device 12 may rely on hardware support from a Memory Management Unit (MMU) to manage the memory and export functions that other subsystems and applications may use to interact with communications device 12.

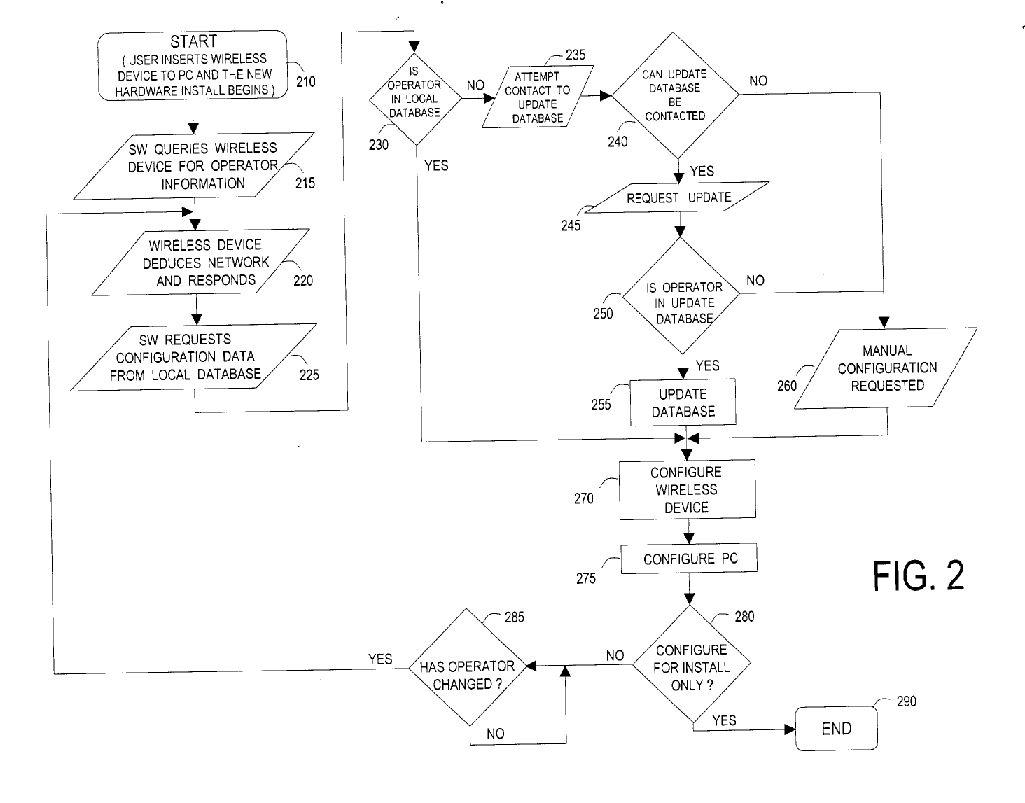

FIG. 2 is a flow diagram that illustrates a method for enabling wireless mobile communications device 12 and its computing host to automatically configure the wireless device. Using this method, wireless mobile communications device 12 may be readied for operation based on measurements made through the wireless device by installation software.

Accordingly, the START process 210 may be initiated by a hardware install such as an insertion or connection of wireless device 12 to a Personal Computer (PC). Following the START process, a process 215 may include a software query or software check that provides operator information stored in wireless mobile communications device 12. One such piece of information may be obtained by a query to the Subscriber Identity Module (SIM) card of wireless device 12 to provide information concerning the identity of the user's home wireless carrier on the available network. Service provider SIM cards for GSM, GPRS and 3G networks, among others, provide subscriber specific operations such as identification, authentication, phonebooks, etc. It is not intended that the types of networks provided in these examples limit the scope of the claimed subject matter. In other words, the features of the present invention may be practiced by wireless device 12 operating in other types of communication networks.

Following process 215, a process 220 instructs wireless mobile communications device 12 to “sniff” or deduce the type of network that is presently available. After determining the current operator and the type of network available for wireless device 12, drivers may be appropriately set. Knowing the current operator, a process 225 instructs wireless device 12 to gather the configuration data corresponding to the current operator or network provider in the local database. An attempt is made by wireless device 12 to retrieve network provider and related settings from the local database. Settings may include the IP address, GSM voice specific features, SMSC numbers, proxy machine addresses, etc. Note that the local database refers to the internal cache and memory arrays (see FIG. 1) as well as external memory connected via a bus to wireless mobile communications device 12.

Decision process 230 determines which of two paths should be taken, the path taken depending on whether the operator settings are stored in the local database of wireless device 12. A first path is determined when the operator settings are not stored in the local database. In this case process 235 attempts to contact the network to retrieve the operator settings. Decision process 240 determines whether the network can be contacted, and if so, a process 245 requests the operator settings through a network connection. Decision process 250 determines whether the operator settings are available. If available, an action process 255 communicates the operator settings to wireless device 12 for storage in the local database. At this point, a determination has been made that a request for operator settings was not stored locally in wireless mobile communications device 12. Recognizing that configuration data stored within the wireless device was missing, the configuration data is gathered remotely with updates received by the wireless device. It should be noted that the updates may be a complete file or a partial file to supplement a file stored locally within wireless device 12.

Action process 270 uses the operator settings to configure wireless device 12 irrespective of whether operator settings were retrieved through processes 235, 240, 245, 250, 255 in the first path, or by a second path from decision process 230 when the operator settings are stored in the local database (see FIG. 2). Thus, wireless mobile communications device 12 may be automatically configured if operator settings are stored locally within the device or available from the network; or the user may manually supply the operator settings if they are not locally stored or retrievable. Using this method, an attempt is made to ready wireless mobile communications device 12 for operation through the wireless device by installation software without user intervention.

Alternatively, if decision process 240 determines that the network cannot be contacted or if process 250 determines that the updated operator settings are not available from the network, then action process 260 determines that manual configuration by the user may be necessary. It is also anticipated that if the network provider data is not available to configure the device, the software may use a generic configuration and request the latest configuration information from the network. By way of example, if the configuration for GPRS (packet data) cannot be made for the detected operator but standard GSM configuration can, then the software may use either a circuit-switch data call or a Short Message Service (SMS) to request the update from a central database on the network. Following the configuring of wireless device 12, action process 275 enables configuring the computing host, i.e., the Personal Computer. Thus, upon receipt of the update, the local database may be updated and configuration proceeds for GPRS on wireless device 12 and the Personal Computer.

In decision process 280, a determination is made as to whether the updated database was for this install only. If it was, then the process ends, 290. If not, then decision process 285 allows wireless device 12 to continuously monitor the network to determine operator changes and make appropriate setting changes on the fly. By way of example, a dual mode device such as a Wireless Local Area Network (WLAN) and Global System for Mobile Communications/General Packet Radio Service (GSM/GPRS) device may detect the available network and switch the settings accordingly to that network provider's settings. Further, by continuously monitoring the network, wireless device 12 may make the appropriate changes that allow a user to roam into a different network of the same technology without disrupting communication. By continuously looping through the processes shown in FIG. 2, wireless device 12 may sense on the fly what the network is and change the configurations for the device and PC automatically. In this manner the user may benefit from being optimized to a location, which may enhance data rates and potentially lower data transfer costs.

By now it should be clear that embodiments have been presented for a system that simplifies the configuration of a wireless mobile communications device and its computing host. The method presented does not require the wireless carrier to initiate an Over-The-Air (OTA) configuration that can be operator specific, but rather configures both the wireless device and the computing device. Thus, the computing device receives IP address information and other settings that are network specific.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
checking a wireless device for configuration data stored locally;
recognizing that the configuration data stored within the wireless device is missing; and
getting the configuration data remotely, wherein these processes of the wireless device do not involve user intervention.

2. The method of claim 1, further including:
determining a type of network by the wireless device for wireless communication to determine the configuration data.

3. The method of claim 1, further including in response to checking the wireless device:
requesting by the wireless device the configuration data stored locally.

4. The method of claim 1, further including:
monitoring the network by the wireless device to determine when updated configuration data is needed.

5. The method of claim 4, further including:
recognizing that the network has changed.

6. The method of claim 5, further including:
automatically checking the wireless device again for configuration data stored locally.

7. The method of claim 4, further including:
requesting the updated configuration data from the network by the wireless device without user intervention if the configuration data is not stored locally within the wireless device.

8. The method of claim 1, further including:
storing the updated configuration data locally in the wireless device and further storing the updated configuration in a processor.

9. A method comprising:
automatically configuring a wireless device for communicating without user intervention using a locally stored database within the wireless device before requesting a remote database if the locally stored database is missing.

10. The method of claim 9, wherein automatically configuring includes:
determining by the wireless device a type of network for wireless communication to determine configuration data;
checking the wireless device for the configuration data stored locally;
recognizing that the configuration data stored within the wireless device is missing; and
getting the configuration data remotely.

11. The method of claim 10, further including:
using the wireless device to monitor the network to determine that the network has changed.

12. The method of claim 11, further including:
checking the wireless device for the configuration data stored locally if the wireless device determines that the network has changed; and
again recognizing that the configuration data stored within the wireless device is missing; and
getting an updated configuration data remotely.

13. The method of claim 12, further including:
storing the updated configuration data locally in the wireless device and further storing the updated configuration in a processor.

14. A network, comprising:
a processing device having static memory;
a wireless device coupled to the processing device and capable of communications to determine a type of communications network, wherein the type of communications network is used to automatically configure the wireless device without user intervention using locally stored data associated with the type of network before requesting remote data if the locally stored data is missing.

15. The network of claim 14, wherein the wireless device further comprises a memory to store the locally stored data.

16. The network of claim 15 wherein the wireless device receives the remote data to store in the memory of the wireless device.

17. The network of claim 14, wherein the locally stored data is in the static memory of the processing device.

18. The network of claim 17, wherein the wireless device receives the remote data to store in the static memory of the processing device.
